(19) United States
(12) Patent Application Publication
(10) Pub. No.: US 2012/0246069 A1
(43) Pub. Date: Sep. 27, 2012

(54) FUNDS NETWORK AND METHOD

(76) Inventors: Drew W. Edwards, Canton, GA (US); Richard D. Storey, Duluth, GA (US)

(21) Appl. No.: 13/234,066

(22) Filed: Sep. 15, 2011

Related U.S. Application Data
(60) Provisional application No. 61/467,814, filed on Mar. 25, 2011.

(51) Int. Cl. G06Q 40/02

(52) U.S. Cl. 705/42

(57) ABSTRACT

In a method of providing funds to a monetary repository, information is received identifying a payee and request by the payee to convert a negotiable instrument made to the payee to funds. In response to the information, confirmation is received whether to convert the negotiable instrument to funds. An image of the endorsed negotiable instrument is received. If a determination is made to convert the negotiable instrument to funds, an amount of funds corresponding to a value of the negotiable instrument is directed to a repository.

### CLAIM OF PRIORITY

This application claims priority to U.S. Provisional Patent Application Ser. No. 61/467,814, filed Mar. 25, 2011, the entire disclosure of which is incorporated by reference herein.

### BACKGROUND OF THE INVENTION

Services have existed for converting negotiable instruments into good funds. As used herein, “good funds” refers to funds that are transferred to a recipient without risk on the recipient's part that the funds will be reversed. Currency is a traditional form of good funds when transferred without underlying contractual obligations, but good funds also encompass electronic and other non-physical currency value transferred without recourse against the recipient.

A person in possession of a negotiable instrument may need to direct funds to accounts that are associated with the person, such as prepaid card accounts, invoice accounts, or direct deposit bank accounts, or other functions such as money transfers. Depending on the desired destination, the account manager may accept funds in various forms. For instance, a local public utility might accept checks drawn on direct deposit bank accounts. Managers of pre-paid services accounts generally do not accept checks but may accept funds delivered by direct deposit payroll files to their bank accounts. Where the person does not have a deposit bank account or, in the case of prepaid services, a payroll direct deposit relationship, however, the managers generally require a source of good funds in order to finalize receipt of the funds such that the funds are available for the intended purpose. A prepaid card issuer, for example, requires good funds be received into an account in order to make the funds available for withdrawal through use of a prepaid card associated with the account.

A person in possession of a negotiable instrument such as a check (for ease of example, the discussion herein refers to checks, but this is for purposes of explanation only, and it should be understood that the present discussion can encompass other types of negotiable instruments) may acquire good funds through a check cashing entity that makes a unilateral decision, in some cases based on its own criteria and upon information it may acquire from the instrument holder or a check risk management service, whether to cash the check. Alternatively, the check cashing entity may have a relationship with a check guarantor service, under which the check cashing entity provides certain predetermined information to the check guarantor, and in response to which the check guarantor approves or denies the check. If the check cashing entity decides to cash the check, alone or in conjunction with a check risk management service or guarantor, the check cashing entity may provide currency to the instrument holder, less a fee, and the holder endorses the check over to the check cashing entity.

If the check cashing entity cashes the check and provides currency to the check presenter, the presenter may then present currency to managers of respective accounts to which the presenter desires to direct funds. Alternatively, some check cashing entities provide an additional service of directing good funds to such account managers.

For example, assume a consumer presents a retailer with a check made to the consumer and that the retailer makes a determination, either locally or with the assistance of a check risk management service or guarantor, to cash the check. Following that decision, or in some instances prior to check verification, the consumer endorses the check over to the retailer and provides instructions to the retailer regarding an account to which the consumer wishes to direct funds.

The retailer then directs good funds in the amount of the check or some portion thereof, less fees charged to the consumer, to the desired account, for example via a load network. The load network is an entity that maintains a server system that can be accessed remotely, typically over the Internet or through a link to a retailer's point of sale system. The load network maintains contractual agreements with managers of prepaid debit card accounts that allow the load network to direct funds to the prepaid accounts. The load network also maintains contractual agreements with check cashing entities (e.g. the retailer in this example) under which the load network has the ability to transfer funds involved in a transaction from designated deposit accounts owned by these entities. Accordingly, when the retailer receives and decides to cash the consumer's check, and when the consumer provides instructions to the retailer directing the retailer to direct check proceeds to a reloadable prepaid card, the retailer accesses the load network server and provides an instruction to the load network to transfer an amount of funds equal to the check value, less fees charged to the consumer, to an account associated with the card issuer. In response, the load network transfers the requested amount of funds from the retailer's deposit account designated in the agreement between the retailer and the load network to the requested prepaid card account. The load network may also transfer to itself a portion of the fee, again pursuant to the agreement between the retailer and the load network.

Through the load network, the retailer provides funds to the prepaid card account manager without recourse either to the load network or the account manager in the event the check returns. For example, if the check is returned for insufficient funds or other reasons, the retailer does not reverse the transaction back to the load network and/or the card issuer. In some instances, there may be an agreement between the retailer and the card issuer under which funds may be reversed in order to facilitate collection on the check, but such agreement does not relieve the retailer of ultimate responsibility for the funds if the check is not collected. The funds transfer remains in place, and liability thus rests with the retailer. If the retailer contracts with a check guarantor, the retailer may mitigate its risk by allocating some or all of the retailer's risk to the check guarantor, but regardless, liability rests with the retailer from the perspective of the load network and the card issuer.

In this system, the load network derives revenue (i.e. a fee assessed from the fee retained by the retailer from the check proceeds, as described above) from the transactions independently of the card issuer and/or the entity managing the card accounts. The prepaid issuer typically pays for membership in the load network but isn't charged a per-transaction fee for the receipt of good funds. The prepaid card issuer retains its fee from the load amount received from the load network. This fee arises from the agreement between the card issuer and the consumer and is independent of the relationship between the card issuer and the load network. In some cases, when the retailer decides to cash a check and then load the proceeds onto a prepaid card through a load network, the retailer waives all or some part of either the retailer fee to cash the check or the load network fee, but this is independent of the card issuer.

In another arrangement, a load network may sell at retail locations coupons that are assigned predetermined monetary amounts. A consumer selects a coupon and presents the coupon to a clerk at a retail point-of-sale device. The check out clerk scans or otherwise enters information into the point-of-sale device identifying the coupon and its amount, and the point-of-sale device registers a charge equal to the coupon's predetermined amount, plus a fee. This total is paid by the consumer to the retailer, who retains the fee and remits the coupon's predetermined amount to the load network. If the consumer has a reloadable card issued by a card issuer having a relationship with the load network, the consumer may contact the load network (e.g. by telephone) and instruct the load network to allocate the coupon amount to the card. The load network then transfers the amount from its account to an account at the card issuer.

Check guarantors may have consumer-accessible outlets (e.g. at retail or stand-alone facilities) at which a consumer may present a check for cashing.

Referring to an exemplary prior art transaction 10 illustrated in FIG. 1, a consumer 12 has a plurality of checks 14 in a physical wallet 16. The checks are made to consumer 12 as the payee. Consumer 12 presents the checks to a check cashing service provider 18, which could be a retailer or a stand-alone check cashing entity. If the consumer has an existing deposit account and credit relationship with a bank, the consumer could simply cash the check through the deposit account bank. Even if the consumer has such a banking relationship, however, the consumer may not have sufficient knowledge about the check maker to have confidence in the funds. If the consumer cashes the check at the direct deposit bank, the bank will generally charge the check amount back to the consumer in the event the check is returned. Check cashing service provider 18 may have recourse against the consumer but, as a practical matter, may not be sure of its ability to recover the check funds. Thus, as noted above, the check cashing service provider typically accepts the risk of the check being returned and therefore charges a fee to the consumer for cashing the checks.

Assuming consumer 12 presents the check to check cashing service provider 18, an operator at the facility may acquire identification information from the consumer, e.g. orally and/or through inspection of identification documentation such as a drivers license, and query a check guarantor or risk management service (e.g. through a local network or an Internet connection) regarding whether the consumer is enrolled in its system. If, after receiving the consumer information, the check guarantor or risk management service does not have a record for the consumer in its system, the check guarantor/service responds to the check cashing service provider with a message that the consumer is not enrolled in the system. The operator then requests further information from the consumer and forwards the consumer information to the check guarantor/service. Assuming the consumer is enrolled, or becomes enrolled, the operator may acquire information about the check, for example the payee, the maker, the maker's bank, the amount, the type of check, and the date. The operator may acquire check information through visual inspection of the check and/or by scanning the check to read the magnetic ink character recognition (MICR) data and/or for remote inspection. Check validation may occur locally at the check cashing service provider but may also be made in conjunction with the remote check risk management service and/or guarantor. A risk management service advises a check cashing entity about risk, whereas a guarantor accepts the risk of cashing a check. Assuming validation via a remote entity, the operator at check cashing service 18 may communicate (e.g. through a local network or an Internet connection) the check information to the check guarantor or risk management service.

The check guarantor/service assesses a risk in cashing the check, based on the consumer information, the check information, database information, and potentially other factors. The risk assessment may be entirely automated, or it may be supplemented by human evaluation. Based on the assessment, the check guarantor/service communicates (through an electronic message and/or by voice communication) a decision to the operator at the check cashing facility whether to cash the check. If the decision is that the check should not be cashed, the transaction ends. If the decision is to cash the check, check-cashing service provider 18 provides cash to the consumer, ending the transaction.

While check cashing services traditionally have been provided by companies for which check cashing is the company's only business, more recently retailers, banks and other businesses choose to offer this service.

At 13, after obtaining cash for a check, the consumer may utilize the cash to acquire prepaid services or otherwise allocate the cash. In some instances, this may occur as a net transaction from the consumer's perspective, without the consumer ever receiving physical currency. Nonetheless, there are two separate transactions (i.e. (a) check cashing and (b) funds allocation, where the second transaction involves the account manager, but the first (i.e. check cashing) occurs independently of the account manager.

For example, the consumer may allocate the funds to a reloadable pre-paid card, at 20. Prepaid cards, of various types, have been known for many years, generally beginning with closed loop gift cards and evolving into today's general purpose reloadable (“GPR”) cards. Prepaid cards can be generally classified as reloadable or single load cards. Single load cards are static. Once purchased and assigned a value, they cannot be reloaded with additional funds. In contrast, re-loadable cards can be replenished with funds after their initial purchase. Single load cards can be purchased anonymously. As there is no need to identify the purchaser, the single load card itself carries no information about the customer/purchaser. In contrast, a reloadable card is, in essence, backed by a bank account and is therefore associated with card owner identification information. The bank is responsible for completing identity verification in compliance with a written customer identification policy (“CIP”).

Although a reloadable card is generally issued by a bank, the cards and their associated accounts are generally managed by a separate entity, and thus the term “account manager” is used herein. Thus, with respect to a reloadable card, the term “manager” should be understood to refer to the bank and/or a separate managing entity, if applicable.

If the consumer wishes to load the check proceeds to a reloadable card, but does not yet have a card, the consumer may acquire a card from a vendor or directly from a reloadable card account manager, for example via the Internet or retail outlets. In such a transaction, the consumer enrolls with the card account manager by providing information to set up an account in the card account manager's system.

Assuming the consumer has a card, the consumer provides that portion of the now-acquired cash the consumer wishes to allocate to the prepaid card account to a vendor having a relationship with either the card manager or a load network. Through such relationships, the vender loads, in essence deposits, the proceeds onto the card, i.e. into an account associated with the card, at the account manager. The consumer fee associated with this load is typically deducted from the proceeds and retained by the vendor and the load network.

For example, assume a consumer purchases or reloads a card at a retail facility at which the consumer cashes a check. If the consumer is not enrolled in the card manager's system, the consumer may provide enrollment information at the retailer's customer service desk, which communicates with the card manager over a network connection to enroll the customer. Upon enrolling, or if the consumer has an existing card, the customer may proceed to a retailer checkout station. A checkout clerk swipes the card through a magnetic card reader at the clerk's point of sale device. The point-of-sale device reads the card, acquires card information from the card, and communicates that information to a load network. Upon being informed by the consumer of the amount the consumer wishes to load to the card, the clerk enters the requested amount (plus a fee) through the point-of-sale device keyboard and accepts the cash proceeds from the consumer. The point-of-sale device electronically notifies the load network that the check proceeds have been accepted for allocation to the card manager account associated with the card (via the card number read by the point-of-sale device). Pursuant to an agreement between the load network and the retailer, the load network transfers the requested amount from an account owned by the retailer to the card manager account. The load network transfers a portion of the fee to the load network, with the remainder of the fee remaining in the retailer's account.

Consumer 12 may also allocate some or all of the check proceeds to a money transfer at 22. As should be understood, a money transfer is a remitter-to-recipient service maintained by a service provider, for example WESTERN UNION. The consumer manually presents the desired funds to the money transfer service provider and instructs the service provider to allocate the designated amount of funds for transfer to a designated recipient. Consumer 12 may also allocate some or all of the check proceeds to an automatic bill paying account, such as provided by services such as CHECKFREE PAY, at 24, purchase a money order from a money order provider at 26, and/or pay for a prepaid telephone card at 28. At any of these steps, the manager (i.e. WESTERN UNION, CHECKFREE PAY, the money order provider, or the telephone card provider in these examples) may charge a fee to the consumer. A retailer may provide access to such managers, such that the consumer may allocate funds to the repository managers at the retail check out system, as individual transactions.

### SUMMARY OF THE INVENTION

One or more embodiments of the present invention may recognize and address disadvantages of prior art constructions and methods as described above.

In one embodiment, a method of providing funds to a monetary repository, where the funds originate from a negotiable instrument made to a payee, includes providing a computerized system that is accessible to remote parties through a computer network and that is controlled by an entity. Information is received at the computerized system through the computer network information identifying a payee and indicating a request from the payee to convert a negotiable instrument made to the payee to funds. In response to the information, it is determined whether to convert the negotiable instrument to funds. Through the computer network, an image of the negotiable instrument is received, endorsed to the entity. If a determination is made at the determining step to convert the negotiable instrument to funds, an amount of funds corresponding to a value of the negotiable instrument is directed, through the computer network, to a monetary repository designated by or associated with the payee.

In another further embodiment, a method of providing funds to a monetary repository, where the funds originate from a negotiable instrument made to a payee includes providing a computerized system that is accessible to remote parties through a computer network and that is controlled by an entity. A request to convert a negotiable instrument made to the payee to funds is received at the computerized system through the computer network. An image of the negotiable instrument endorsed to the entity is received at the computerized system through the computer network. Confirmation to convert the negotiable instrument to funds is also received. Payment of an amount of funds corresponding to a value of the negotiable instrument is directed from the computerized system through the computer network, to a monetary repository designated by or associated with the payee. Settlement of the negotiable instrument with recourse to the entity is directed from the computerized system through the computer network.

In a further embodiment, a method of providing funds to a monetary repository, where the funds originate from a negotiable instrument made to a payee, includes providing a computerized system that is accessible to remote parties through a computer network and that is controlled by an entity. Information is received, at the computerized system through the computer network and from an acquirer of a negotiable instrument made to a payee, identifying the payee and indicating a request to convert the negotiable instrument to funds, wherein the acquirer is remote from the computerized system. An image of the negotiable instrument endorsed to the entity is received from the acquirer, at the computerized system through the computer network. Confirmation to convert the negotiable instrument to funds is also received. Payment of an amount of funds corresponding to a value of the negotiable instrument is directed from the computerized system through the computer network to a monetary repository designated by or associated with the payee. Settlement of the negotiable instrument with recourse to the entity is directed from the computerized system through the computer network.

In a still further embodiment, a system for providing funds to a monetary repository, where the funds originate from a negotiable instrument made to a payee, includes a computer-readable medium containing program instructions, and a processor that is accessible to remote parties through a computer network and that is controlled by an entity. The processor is in operative communication with the computer-readable medium and is adapted to execute the program instructions to implement a method including receiving, from the computer network, a request to convert a negotiable instrument made to the payee to funds. An image of the negotiable instrument endorsed to the entity is received from the computer network. Confirmation to convert the negotiable instrument to funds is also received. Payment of an amount of funds corresponding to a value of the negotiable instrument is directed through the computer network to a monetary repository designated by or associated with the payee. Settlement of the negotiable instrument, with recourse to the entity, is also directed through the computer network.

### BRIEF DESCRIPTION OF THE DRAWINGS

A full and enabling disclosure of the present invention, including the best mode thereof directed to one of ordinary skill in the art, is set forth in the specification, which makes reference to the appended figures, in which:

FIG. 1 is a schematic view of a prior art check cashing transaction;

FIG. 2 is a schematic view of a transaction made through an embodiment of the system and method according to the present invention;

FIGS. 3A-3G are a partial flow diagram view of a method according to an embodiment of the present invention; and

FIG. 4 is a schematic view of a system according to an embodiment of the present invention.

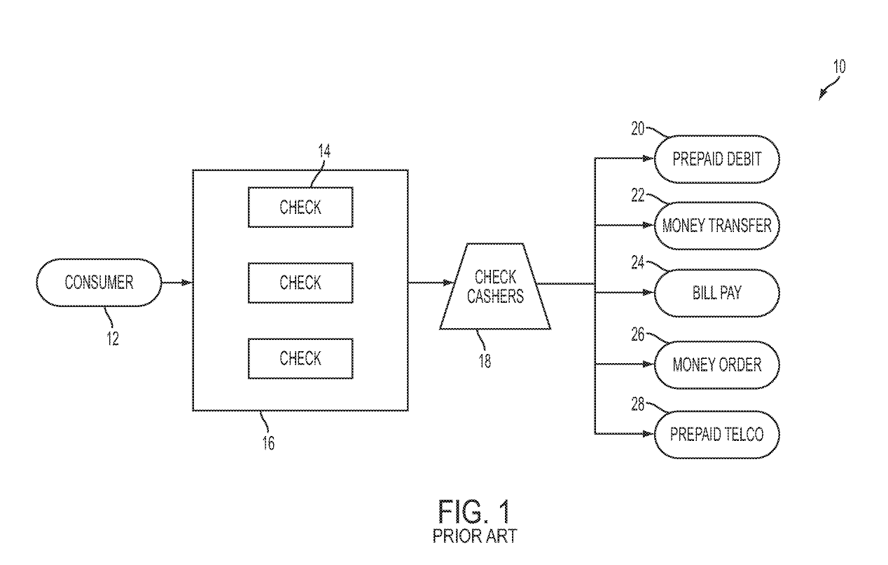

Repeat use of reference characters in the present specification and drawings is intended to represent same or analogous features or elements of the invention.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

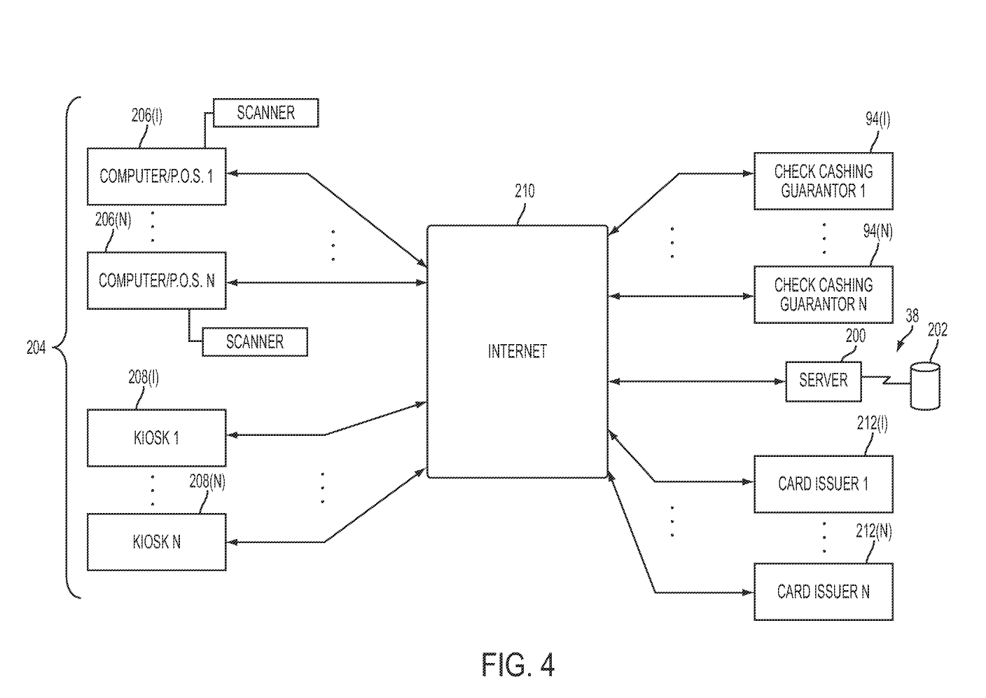

One or more embodiments of the invention described herein are implemented at least partially as and/or using computer programs for use with a computer system, such as, for example, the network environment shown in FIG. 4 and described herein. The programs define functions of these embodiments (including one or more methods described herein) and can be contained on a variety of computer-readable media, for example, information stored on non-writable storage media (for example, read-only memory devices within a computer (for example server 200) such as CD-ROM discs readable by a CD-ROM drive), alterable information stored on writable storage media, and information conveyed to a computer by a communications medium, such as through a computer or telephone network, including wireless communications. The latter embodiment specifically includes information and functions downloaded from the internet and other networks. Such computer-readable media, when carrying computer-readable instructions that direct the functions of one or more embodiments of the present invention, represent embodiments of the present invention.

In general, routines executed to implement embodiments of the present invention described herein may be part of an operating system for a specific application, component, program, module, object, or sequence of instructions. The computer program typically is comprised of a multitude of instructions that may be translated by a computer into a machine-readable format and hence executable instructions. Also, programs are comprised of variables and data structures that either reside locally to the computer program or are found in memory or on storage devices. In addition, various programs effecting methods described herein may be identified based upon the application for which they are implemented in a specific embodiment. However, it should be appreciated that the invention should not be limited to use solely in any specific application or function identified and/or implied herein.

FIG. 4 illustrates a network environment. Client computer systems (e.g. 206, 208, 94 and 212) as described herein include interfaces that enable network communications with other systems (e.g. server 200) over the network. The network may be comprised of remote network connections, among geographically distributed systems, including network connections over the Internet. Each client computer system generally includes a central processing unit connected by a bus to memory and storage (not shown). Each client computer system typically runs an operating system configured to manage interaction between computer hardware and higher-level software applications running on the client system.

Server 200 may include hardware components similar to those used by the client computer systems. Accordingly, server 200 generally includes a CPU, memory, and storage devices coupled by a bus. The server also runs an operating system and may include a runtime component and a database management system. In response to functions performed by an application running on the server, the runtime component may receive queries in response to which the runtime component generates Structured Query Language (SQL) queries that it provides to the database management system for execution in conjunction with database 202.

The network environment illustrated in FIG. 4 is, however, merely an example of one computing environment. Embodiments of the present invention may be implemented using other environments, regardless whether the computer systems are complex multi-user computer systems, such as a cluster of individual computers connected by a high-speed network, single-user workstations, or network appliances lacking non-volatile storage. Further, the software applications described herein may be implemented using computer software applications executed on existing computer systems that are not limited to any currently existing computing environment or programming language, and may be adapted to take advantage of new computing systems as they become available.

In certain embodiments as described herein, users of computer systems interact with client computer systems and/or server 200 using one or more graphical user interfaces (GUI). GUI content may comprise hypertext markup language (HTML) documents (i.e., web-pages) rendered on the computer system using a web browser. In such an embodiment, server 200 may include a hypertext transfer protocol secure (HTTPS) server configured to respond to HTTPS requests from client systems and transmit HTML documents to client systems. The web-pages themselves may be static documents stored on server 200 or generated dynamically using the application server interacting with the web-server to service HTTPS requests. Alternatively, client applications may comprise a database, or query application program running on the client system. The web-browser and application may be configured to allow a user to compose an abstract query, and to submit the query to a runtime component for processing.

FIG. 4 illustrates a system according to an embodiment of the present invention. Although the embodiment is described with respect to funds derived from a check, it should be understood that funds may be derived from other negotiable instruments, such as time drafts or promissory notes, within the scope of systems and methods encompassed by the present invention. A funds network 38 is embodied by one or more computer servers 200 and databases 202. Although a single block is indicated for computer server 200, and a single block for database 202, it should be understood that the network may be comprised of multiple servers and databases, whether located locally and networked through a local area network or remotely through a wide area network or an Internet connection. Thus, the single representations at 200 and 202 are provided for purposes of illustration only and should be understood to represent such other configurations. Moreover, particularly where a consumer interacts with the funds network through an automated teller machine or other automated device, such as kiosks 208(1)-208(N), the funds network may be considered to include such automated devices.

A plurality of check cashing entities, represented at 204, may comprise stand-alone check cashing facilities 206(1)-206(N) and/or a plurality of unmanned automated teller machines or kiosks 208(1)-208(N), all in communication with server 200 through remote connections, for example through the Internet 210. In general, the check cashing entities are remote from the funds network in that the check cashing entities and the funds network do not communicate over a common communications wired or wireless link, but rather communicate over a communication network or system that is independent of both the check cashing entity and the funds network. Further, all communications between and among remote parties and entities as described herein are, in at least one embodiment, made over secure communication channels, e.g. employing encryption techniques. Encryption methods and systems should be well understood, are not part of the present invention in-and-of themselves, and are therefore not discussed in further detail herein.

Stand-alone check cashing facilities 206 may be respectively operated by an on-site human operator and may be operated by the owner of, and as part of, funds network 38 or by a retailer or other entity unrelated to the funds network or by the consumers themselves through a mobile device via an application loaded on the mobile device. In a mobile environment, a mobile telephone application performs the kiosk functions as described herein, so that the telephone performs as the kiosk. Each facility 206 comprises a computer with a data entry or capture device or devices, for example a keyboard, card reader, and check scanner through which the operator communicates with funds network 38 and server 200 to provide information relevant to the transaction, as described in more detail below. Kiosks 208 may also have a similar configuration, with the same data entry or capture devices. Where a mobile device is used, data may be keyed into the device, and a check image may be captured by a camera on the phone. Computer software resident on the terminals or in a cloud configuration effect the transactions described in more detail below. Where funds network 38 owns and/or operates the check-cashing entity, it performs both the check-cashing entity and funds network roles as described herein, and it should be understood that operation as the funds network does not preclude the network's operation also as a check-cashing entity or other component of the transaction, such as a check guarantor. In general, the check cashing entity is the acquirer of the negotiable instrument in that the check cashing entity acquires possession of the negotiable instrument from the payee (or a transferee from the payee) for purposes of converting the negotiable instrument to funds, through a settlement system. From the payee's perspective, the acquirer is the immediate intermediary between the payee and the settlement process.

Terminals and/or servers located at check cashing guarantors 94(1)-94(N), and a plurality of prepaid card issuers/managers 212(1)-212(N) communicate with funds provider server 200 through respective Internet connections. As should be understood in this art, card issuers are generally banks, but the accounts associated with cards issued by the banks are controlled by other entities, the managers, that maintain the accounts and manage transactions relating to the cards. It should also be understood that funds recipients/repositories may include entities other than card issuers/managers, and thus additional blocks 212 could be shown in FIG. 4 to represent such other entities. Thus, the description of card issuers/managers is solely for purposes of explanation. Each entity in FIG. 4 maintains its own computer systems, which may comprise workstations, servers and/or other computing devices, databases and local networks, independently of the funds network.

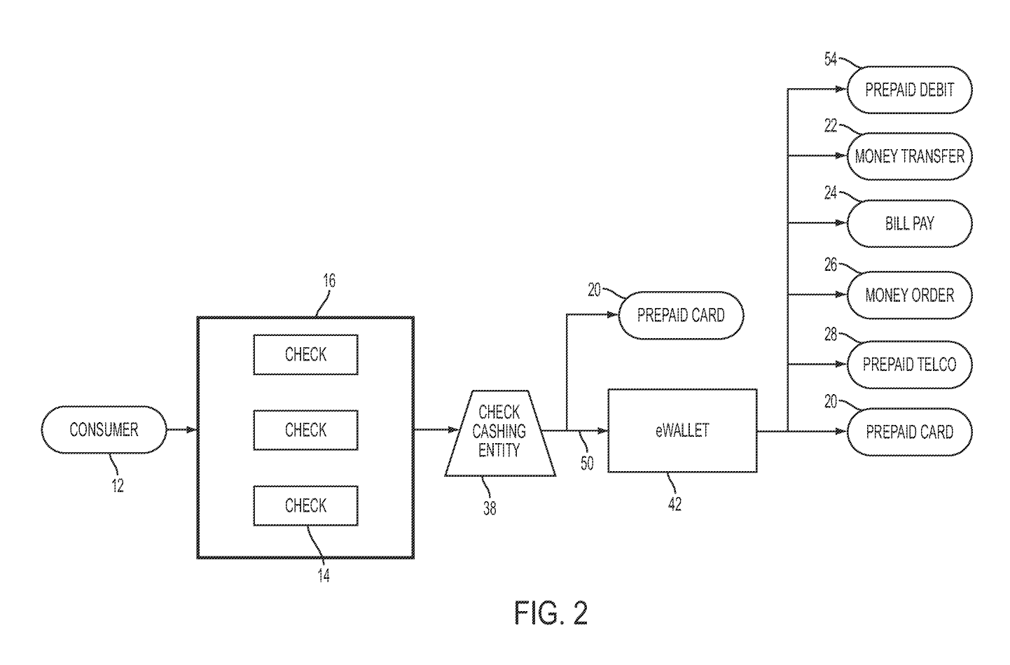

Also referring to FIG. 2, a consumer 12 may present one or more checks 14 to funds network 38 via a check cashing entity at 206 or 208 to obtain funds. The consumer is the check payee (who may be a transferee), and the check cashing entity takes possession of the one or more checks from the consumer, who requests the check be converted to funds. The check cashing entity forwards to the funds network information that identifies the consumer and the request. Funds network 38 provides funds to a monetary repository as requested by consumer 12, in this example a prepaid card provider who then provides funds to consumer 12 after the funds network validates the check in conjunction with a check cashing guarantor. In one embodiment, and as described in more detail below, funds network 38 validates the check through a check guarantor selected from a plurality of available guarantors according to a predetermined algorithm, and may access a greater amount of relevant data in making the check verification than is practically available to any single guarantor other than the funds network.

As described in more detail below, consumer 12 may present a check to funds network 38 directly (for example through a kiosk 208 or a funds network-operated check cashing service location 206) or indirectly (for example through a retailer-operated service location 206). Assuming the funds network decides to convert the check to value, funds network 38 provides good funds to the prepaid card provider, who then makes the funds available to the consumer through a card. Generally, the consumer endorses the check to the funds network rather than to the check-cashing entity, and the funds network presents the check through a payment processing system for payment with recourse to the funds network. Thus, funds network 38 provides good funds to repository managers, for example prepaid access providers, without the check-cashing entity involved in the settlement loop and without the check-cashing entity, and possibly without the repository manager (where the funds network and the repository manager are separate entities), assuming liability for those funds in the event of returned checks.

Also as described in more detail below, one embodiment of funds network 38 may have access to multiple check guarantors and offers an auction to the guarantors to provide check guarantees. Because the funds network handles and records check transactions from multiple guarantors, funds network 38 may provide a greater breadth of transactional data to a given check guarantor in a given check-cashing transaction than the guarantor would be able to access if the guarantor were handling the transaction independently of the funds network, thereby enhancing the likelihood the check cashing verification decision is correct. In an embodiment in which the funds network aggregates a plurality of guarantors, the funds network 38 may provide a higher probability of approval and/or a lower cost approval by broadening the spectrum of guarantors on any given guarantee request.

In a still further embodiment, funds network 38 may provide an electronic wallet (e-wallet) into which a consumer can direct proceeds from a check and from which the consumer can allocate funds into repositories such prepaid access accounts or service accounts (e.g. for paying invoices to service providers).

Funds network 38 maintains one or more deposit bank accounts in one or more banks or other financial institutions. The funds network maintains a customer record in a table of database 202 of each consumer who has enrolled with the funds network. The customer record indicates whether the consumer has registered with the funds network for an e-wallet. For each such consumer, the database customer record indicates the amount of funds allocated to that consumer's e-wallet, and the funds network maintains a corresponding amount in its bank account(s). The consumer and funds network 38 enter an agreement governing terms and conditions under which funds network 38 maintains the consumer's funds in the e-wallet account and under which the consumer may draw from that account. Alternatively, an entity separate from the load network may own the e-wallet account and operate as described herein based on a contractual arrangement with the load network. When the consumer loads a check through the funds network, the system may automatically direct the proceeds to an e-wallet, if the consumer has an e-wallet account, or the system may provide a query option through which the consumer can request that the proceeds be deposited in the consumer's e-wallet. In that event, when funds network 38 obtains a guarantee on the check, the funds network deposits the proceeds into the funds network e-wallet associated bank account and credits the consumer's record in database 202 accordingly.

More specifically, Assume that the consumer presents a load request to the funds network by swiping a pre-paid card at a kiosk 208 or computing device 206 such that the kiosk or computing device submits the card number to server 200 through an Internet or other network connection. Prior to verifying the check for loading as described above, the funds network checks the card number against a table in database 202 that contains customer records. These customer records include all card numbers associated with consumers enrolled in the funds network and also indicate whether each consumer has registered for an e-wallet. If server 200 determines from the card number received as the load request that the card number is associated with an e-wallet, server 200 identifies the consumer associated with the card in the database table and proceeds through the check verification and cashing procedure described in more detail below. If check-cashing concludes successfully, the funds network loads check proceeds to the consumer's e-wallet account as indicated at 42 in FIG. 2, or possibly another account the consumer may establish in the process.

If the card number is not associated in database 202 with an e-wallet account, server 200 acquires the bank identification number (BIN) from the card number and checks a table in database 202 to determine whether the (BIN) is associated with a card issuer who has enrolled with the funds network. Alternatively, as the table may be configured to correlate card issuers with the entire card number, so that the table lists all cards of that issuer involved in transactions, the system could locate the customer with the full card number. In either arrangement, server 200 determines whether the card has been issued by an enrolled card issuer. Enrollment represents a prior contractual arrangement between funds network 38 and each participating card issuer that allows funds network 38 to automatically access the card issuer's computerized system and provides for the settlement of funds with the card issuer. If the card is associated with an enrolled card issuer, the funds network proceeds through the check verification process as described in detail below. If the check verification is successful, funds network 38 loads check proceeds to the card, as indicated at 20 in FIG. 2.

Alternatively, funds network 38 may offer the consumer a choice, through a user interface, to allocate proceeds of cashed checks to a prepaid card account (or other prepaid access account) or an e-wallet. For example, prior to verifying the check for loading as described above, the consumer may be prompted (by an automatic screen display driven by a user interface or manually by an operator) to select whether to apply check proceeds into e-wallet 42 or directly onto a prepaid card or other prepaid access account at 20. If the consumer elects to deposit funds in a prepaid card or other prepaid account, the consumer may select that option through the user interface at a kiosk 208 or may inform the service provider operator who, in turn, communicates the choice to funds network server 200 via the operator's terminal. If the consumer selects the e-wallet, the funds network acquires the consumer's prepaid card number and locates the consumer's e-wallet account, as described above. If the consumer selects the prepaid card, the system acquires the card number and determines whether the card issuer is enrolled in the funds network, as discussed above.

Whether selection between the prepaid card account and e-wallet is automatic or selected, and as described in more detail below, the funds network then proceeds to acquire data and verify the check. Assuming the check verified, the funds network allocates check proceeds to the card or the e-wallet.

The consumer may later wish to allocate funds from the e-wallet to various repositories. To do so, the consumer accesses server 200 via a username/password log-in procedure (or by swiping a card issued by a prepaid card provider enrolled in the funds network, biometric data or other security mechanism) on a funds network kiosk 208 or a consumer mobile or other computing device 206 that connects directly with server 200 through an Internet connection by requesting a uniform resource locator (URL) associated with server 200 through an Internet web browser that is located on the consumer's computing device. The consumer may access the funds network server in various ways, for example a WAP-enabled device. In response to access by consumer 12, a computer program executed by server 200 presents the consumer with the user interface on the consumer's computing device, and the user interface provides the consumer the choice between executing a load transaction and accessing the consumer's e-wallet account. Alternatively, if the consumer is already in communication with server 200 through such a connection for conducting a load transaction as described herein, the consumer may simply select an e-wallet allocation option instead of or after the funds load function, thereby changing to allocation mode. Once in e-wallet allocation mode, server 200 presents the consumer with a screen indentifying the consumer's e-wallet balance and prompting the consumer for instructions regarding allocation of e-wallet funds. The user interface presents a list of prepaid cards associated with the consumer database 202, along with a list of other monetary repository providers enrolled in the funds network and, possibly, associated with the consumer. Through the user interface, consumer presents an instruction to server 200 to allocate funds from the consumer's e-wallet account to the consumer's desired repository.

Assume, for example, that the consumer selects a prepaid card 20. The user interface then prompts the consumer to enter a desired amount to allocate from the e-wallet to the card. After the funds network receives the instructions, it effects a funds transfer of the requested amount to the account manager associated with the card, and the card account manager credits the consumer's prepaid account by that amount, less any fees assessed by the card issuer. The funds network may also debit a fee for the funds network as disclosed in the terms and conditions of an agreement between the funds network and the consumer. The network transfers the moneys owed to the prepaid card issuer at an agreed upon settlement date in the future via electronic transfer.

Through the user interface, consumer 12 may provide instructions to server 200 to allocate some or all of the funds in the consumer's e-wallet to other monetary repositories controlled by managers that have contracted with the funds network to allow the funds network to load funds to their accounts, and the consumer may select such other repositories through the server 200 user interface. For example, the user interface may provide the consumer the option to allocate funds from e-wallet 42 to a money transfer at 22. After selection of this option through the user interface, the user interface prompts consumer 12 to identify the money transfer service provider (e.g. WESTERN UNION), the recipient, and the amount of the proceeds to be directed to the money transfer account. Funds network 38 has a preexisting contractual relationship with the service provider under which the funds network feeds the service provider's application program interface (API) to the consumer's computing device and through which the consumer requests the money transfer. Pursuant to the agreement between the funds network and the money transfer service provider, a settlement process debits an account associated with the funds provider and credits the debited amount to an account owned by the money transfer service provider through an automated clearing house or other electronic transaction on a predetermined settlement date. Also pursuant to such agreement, the API preferably reports to the funds network the transferred amount.

Similarly through the user interface, consumer 12 may allocate funds from e-wallet 42 to an automatic bill paying account, such as provided by services such as PAYPAL at 24, a money order at 26, a prepaid telephone card at 28, or other desired monetary repository.

In the presently-described embodiment, the funds network charges fees on funds loaded to monetary repositories that are set by an agreement between the funds network and the repository manager. The repository manager therefore knows the fees that are ultimately borne by the consumer based on the funds network, and may therefore consider that information in setting its own fees. Of course, in a situation in which the funds network is also the repository manager, the funds network can control fees related both to the funds network function and the repository function.

In one preferred embodiment, funds network 38 requires that all proceeds of a cashed check be submitted to the funds network, without retention of a partial amount for distribution to the consumer in currency. However, after allocating the entire check proceeds to a prepaid card at 20 and/or an e-wallet at 42, server 200 may prompt the consumer (directly through a user interface if the consumer is communicating directly with the funds network through a funds network kiosk 208, or indirectly via an operator if the consumer is communicating with the funds network through a manually operated check-cashing entity) to request whether the consumer desires to receive currency in a cash-back transaction. If the consumer replies in the affirmative and identifies a source for the funds (e.g. a prepaid card or e-wallet account), server 200 instructs kiosk 208 to dispense that amount of cash to the consumer in currency, or instructs the service provider operator to do so. In the former situation, the load network charges the dispensed amount against an internal account and, if the consumer designated the funds be charged against a prepaid account, later settles the amount with the prepaid account manager by electronic funds transfer. If the consumer designated withdrawal from an e-wallet account, the load network settles the amount with the e-wallet account internally or, if the e-wallet account is managed by a third party, with the third party manager. In the latter case, the service provider later settles the dispensed amount from funds network 38, and funds network 38 then settles with the source of the cash-back funds. Alternatively, and particularly where the service provider is a retailer, the consumer may not have a cash back option. In a still further embodiment, load network 38 loads funds directly into prepaid or other repositories 22, 24, 26, 28 and/or 54, without an intervening e-wallet 42.

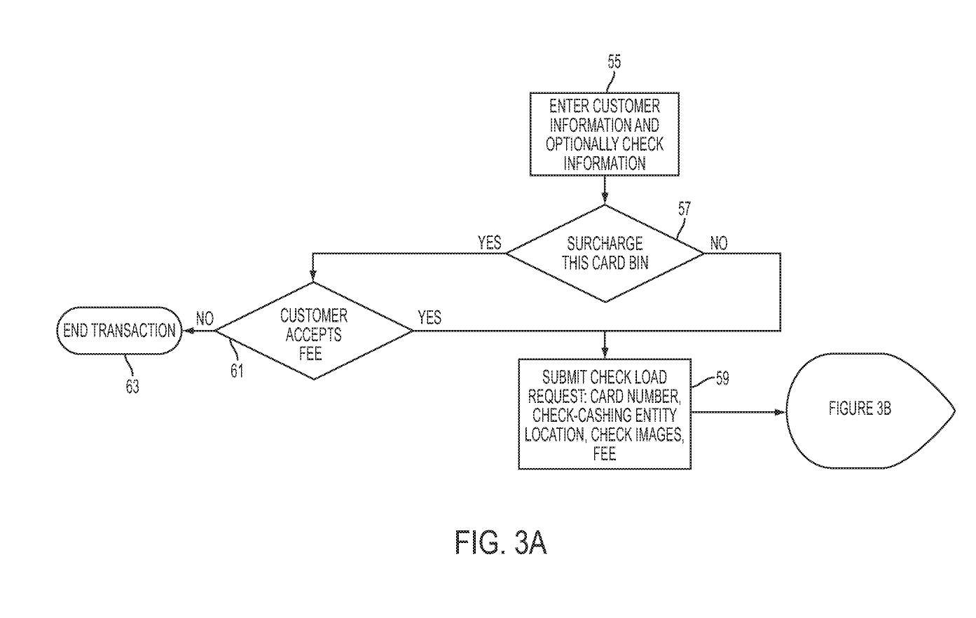

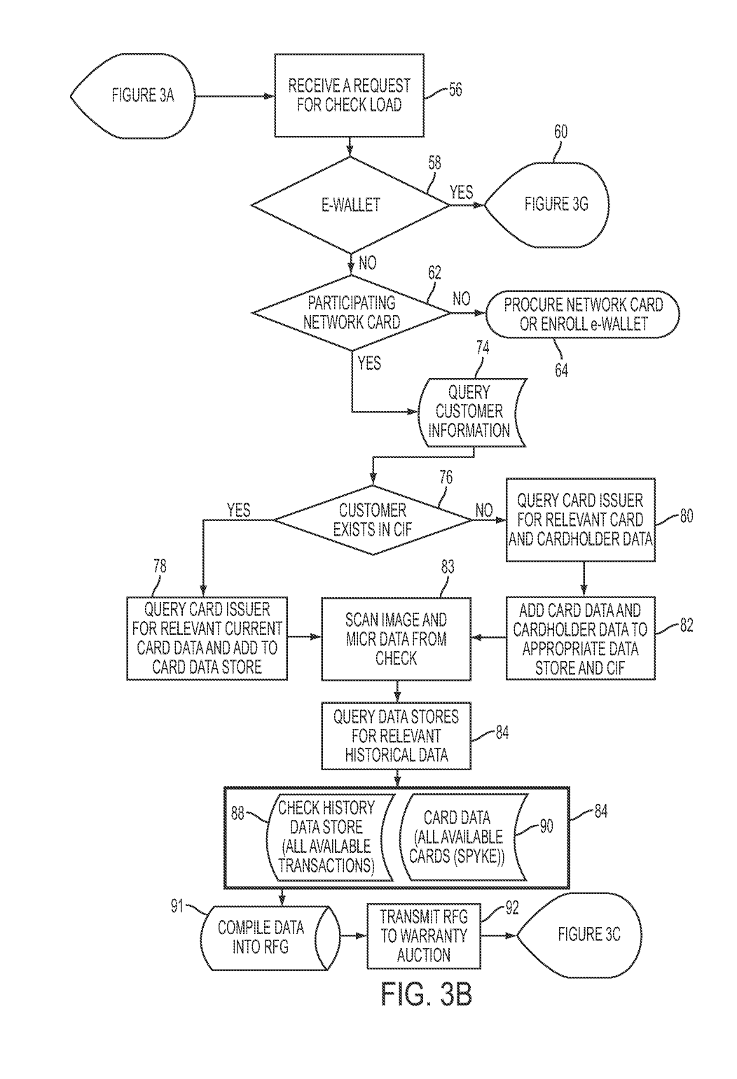

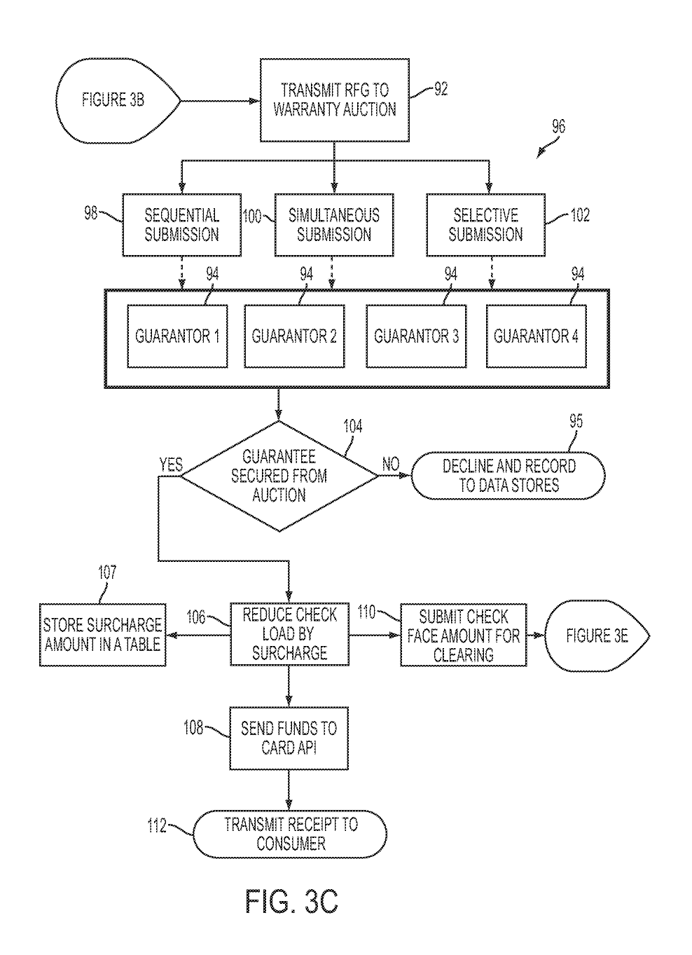

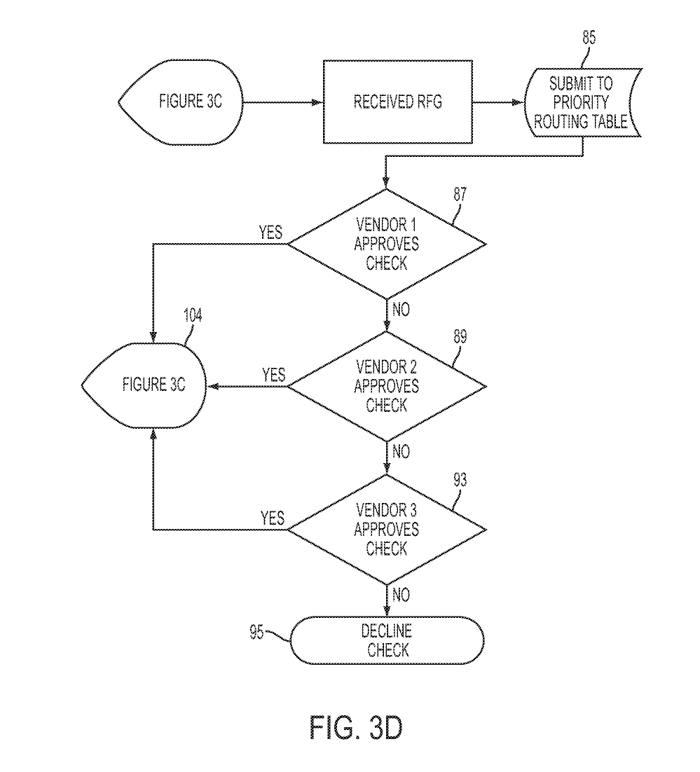

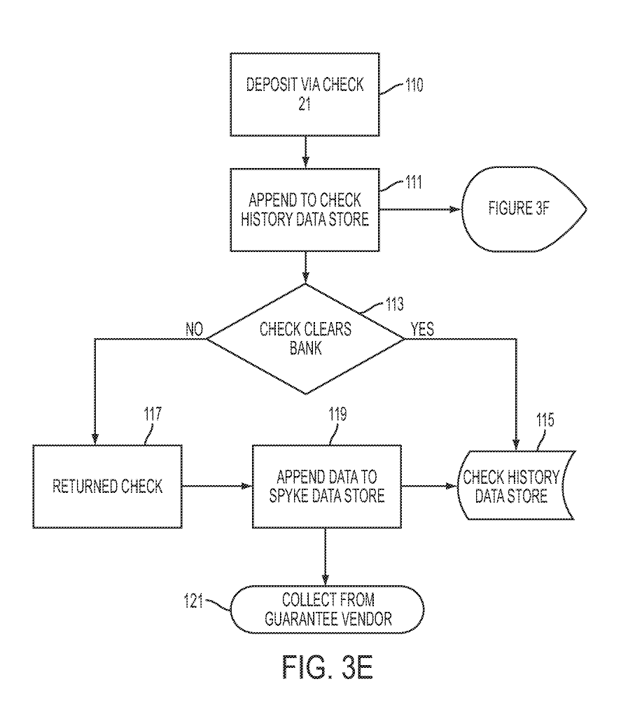

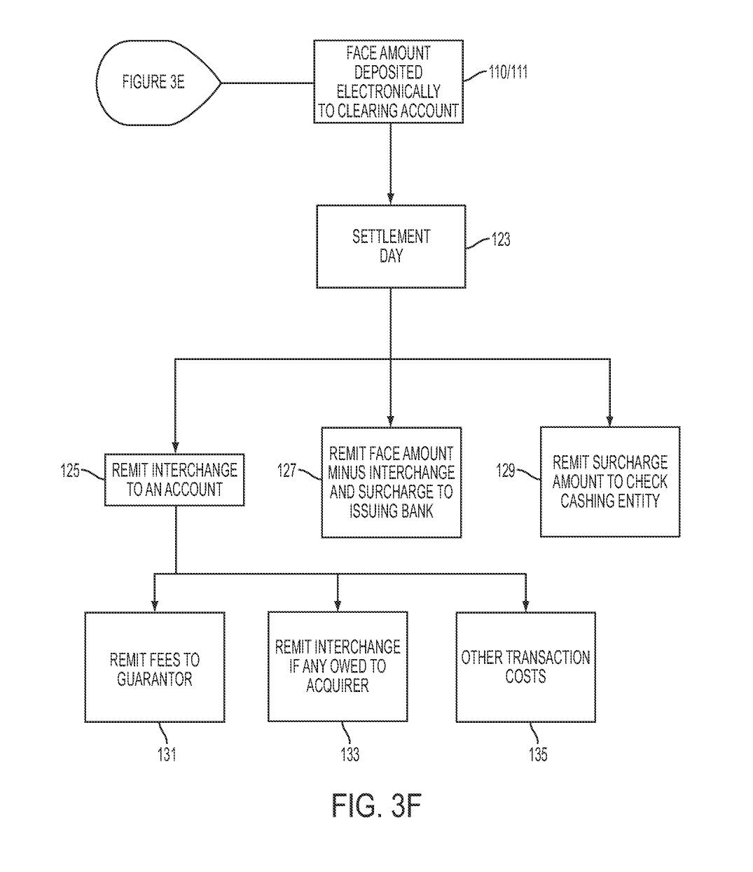

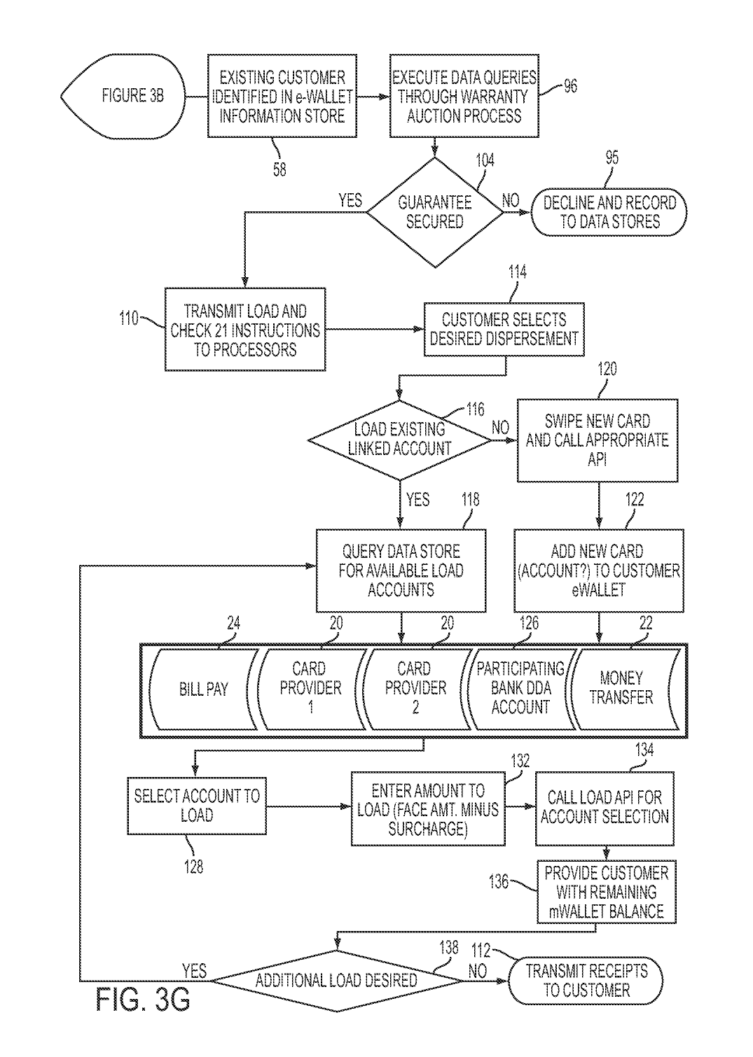

FIGS. 3A-3G illustrate one embodiment of a transaction employing a system as described above. In operation of funds network 38 (FIG. 2), and referring to FIG. 2 and FIG. 3A, a consumer 12 presents one or more checks 14 to the funds network, for example at a retail establishment, or stand-alone service provider 206, or kiosk 208 (FIG. 4), at 55. The kiosk, retailer or service provider obtains consumer identification information at the kiosk 208 or retailer/service provider computer 206, for example by prompting the consumer or operator to swipe a prepaid card associated with an enrolled card issuer or enter the card number by other means.

The retailer, service provider or kiosk may charge service fees for cashing the consumer's checks. This is controlled by the service provider systems independently of funds network 38. For example, the retailer or service provider may have a policy to always charge a certain fee for cashing a check. If so, when the customer information is entered into the service provider's computer system or kiosk at 55 as part of a check cashing transaction, the kiosk or service provider's computer system may automatically associate such fee amount with the customer identification data. Other arrangements are possible, however, and the check cashing entity may selectively waive the fee in its sole discretion. Thus, for example, as shown in FIG. 3A, if the consumer enters customer information into the check cashing entity's system at 55 in the form of a prepaid debit card number, the check cashing entity's system acquires the BIN from the card number and checks at 57 whether the card issuer associated with the BIN is one with which the check-cashing entity has a retail or other commercial relationship such that the check-cashing entity waives the transaction fee. If so, then at 59, the check cashing entity passes the consumer identification information to funds network 38 without the check-cashing entity surcharge.

However, if at 57 the customer identification information is not a card number associated with a card issuer with which the check cashing entity has such a relationship, then at 61 the check cashing entity may present a question to the consumer, for example through a screen display and user interface at kiosk 208 or computer 206, requesting the consumer to confirm whether the consumer agrees to the charge of a fee for the check cashing service. If the consumer does not agree, the transaction ends at 63. If the consumer wishes to accept the additional fee at 61, then at 59 the check cashing entity includes the fee amount with the data passed up to funds network 38.

Note that in the example, the consumer identification information is acquired at 55 by the check cashing entity system, not the funds network system. Pursuant to a prior arrangement between the funds network system and the check cashing entity, the check cashing entity may configure its system to request and acquire certain predetermined customer identity information that the check cashing entity then forwards to funds network 38. The check cashing entity merely acquires this information; it does not analyze or utilize the information to actually identify the consumer. For example, where customer identification information comprises biometric data, the check cashing entity system may acquire the biometric data to pass to funds network 38, but it does not analyze the data to identify the consumer. Similarly, where the identification information is a user name and personal identification number (PIN) sequence, the check cashing entity may present such questions to the consumer, receive the consumer's responses, and forward the responses to the funds network 38, but the check cashing entity does not identify the consumer based on those responses. Where the customer identification information is a prepaid debit card number, whether acquired from a magnetic card swipe or keyed entry, the check cashing entity passes the card number to the funds network without associating the card number with a consumer identity.

As described in more detail below, the check cashing entity may also acquire at 55 an image of the check, for example via a scanner located at kiosk 208 or computing device 206. The check-cashing entity prompts the consumer to endorse the check to the funds network (i.e. the person, corporation, partnership, or other entity that controls operation of the funds network). From step 59, computer 206 or 208 communicates the identification, endorsed check image (if present) and fee (if present) information to server 200 over Internet connection 210. In another embodiment, the imaged check may be passed to the funds network without endorsement, and the funds network prompts the check-cashing entity to acquire the endorsed check after check verification. In such arrangement, the check-cashing entity would confirm receipt of endorsement and so notify the funds network before the funds network submits a load instruction to the card account manager. The timing of the endorsement can vary, but in a preferred embodiment, the agreement between the funds network and the check-cashing entity requires the check-cashing entity to confirm the consumer has endorsed the check and take possession of the endorsed check before some predetermined event or action occurs. For instance, the agreement may obligate the check-cashing entity to take possession of the endorsed check before imaging the check and forwarding the image to the funds network, so that the funds network interprets receipt of the imaged check as confirmation that the check has been endorsed to the funds network.

Referring to FIG. 3B, funds network 38 receives a check load request at 56. The check load request may comprise any format sufficient to notify the funds network that a request has been received. In one presently-described embodiment, the load request is simply the receipt of a reloadable debit card number from the check-cashing entity at 59 (FIG. 3A). Upon receiving the card number, server 200 checks a table in database 202 that associates card numbers with e-wallet accounts, at 58. If the card number is not associated with an e-wallet account at 58, server 200 acquires the BIN from the received card number and checks a second table in database 202 (or, possibly the same table, depending on the data arrangement) that associates BIN's with card issuers and identifies whether the card issuer is presently enrolled with the funds network. If the card issuer is not enrolled with the funds network, server 200 reports this information back to the check-cashing entity over Internet connection 210 and prompts the check-cashing entity to so notify the consumer and recommend to the consumer enrollment with the funds network, at 64, and the transaction ends.

If, however, the card's BIN indicates that the card is enrolled with the funds network, then at 74, server 200 queries the card account manager for the card issuer associated with that BIN number via an application programming interface (API) established pursuant to the enrollment agreement between the card issuer and the funds network. As should be understood, the API may reside locally with the funds network or remotely at the card issuer system or a third-party data center. The arrangement of the API, or generally the mechanism of communication between the funds network and the card issuer, are not in-and-of-themselves part of the present invention and thus not discussed in further detail herein.

In the embodiment described with respect to FIG. 3B, the query at 74 asks only for the identity of the consumer associated with the card number received from the check-cashing entity, for example causing the card account manager to return the consumer's Social Security Number or other predetermined identification indicia via the API. In another embodiment, however, the card account manager returns additional cardholder data, for example the consumer's name, address, city, state, zip code, Social Security Number, tax identification number, or other similar information. Furthermore, the card issuer may also return data relating to the card, for example card status (e.g. open or closed, active or inactive), card issue date, present balance, load limit (i.e. the maximum load allowable), and whether the card is associated with a direct deposit account.

At 76, server 200 checks a table in database 202 that associates the predetermined customer identification information (for example, Social Security Number) with enrollment of individuals associated with that type of identification in the funds network. The table preferably includes customer information, such as name, city, state, zip code, Social Security Number, tax identification number, and similar information. Thus, if the customer identification is present in the table at 76, there is no need for further cardholder data from the card issuer. If the funds network did not acquire current card data at 74, server 200 makes a second query to the card account manager at 78 through the API associated with the card issuer and requests the card data associated with the card number passed from the check-cashing entity at 59 (FIG. 3A). Server 200 adds a record for this card number to a card data table maintained at database 202 that includes the card data as described herein. If the server acquired the card data at 74, however, the query portion of step 78 may be omitted, and server 200 saves the card data record directly from that previously obtained data.

If, at 76, the customer is not present in the customer table of database 202, and if server 200 did not query the card issuer at 74 for cardholder data and card data, then at 80, server 200 queries the card issuer through the API for both types of data. Upon receipt of this information, server 200 creates a corresponding card data record, and a corresponding cardholder data record, in the card data table and customer table on database 202, at 82. If the server acquired the cardholder and card data from the query at 74, step 80 may be omitted and this data directly stored at step 82.

At 83, server 200 sends a request through Internet connection 210 to the check-cashing entity that provided the card number at 59, requesting that the check-cashing entity provide an image of the underlying check or checks involved in the load transaction, endorsed by the consumer. This prompts the check-cashing entity to request the consumer to endorse the check to the funds network and to acquire a check image, for example by scanning the endorsed check at kiosk 208 or computer 206. Server 200 awaits the returned image of the endorsed check. In another embodiment, the check-cashing entity may acquire the endorsed check image initially, so that the check-cashing entity passes the check image along with the card number as part of the check load request from 59. In that event, step 83 may be omitted.

Whether obtaining the check image from step 59 or step 83, at 84 server 200 examines the image and acquires the maker identification from the magnetic ink character recognition (MICR) data in the image. At 88, server 200 checks a transaction record table of database 202. Each record of this table, for example, includes maker identification, check type, check amount, transaction date, payee (consumer) identification, load recipient (i.e. card issuer), and transaction result (for example check cashed or not, check cleared or not, and/or load successful or unsuccessful) for a past load transaction. In the presently-described embodiments, database 202 includes transaction records for all past transactions conducted through the system in which a negotiable instrument was requested to be converted to funds, for instance for all makers and all payees. Server 200 retrieves at 88 all such records listing the maker identified at 84. At 90, server 200 retrieves from this table all such records listing as payee the consumer identified at 74. Thus, the server retrieves all transaction records stored in database 202 for the maker involved in the present transaction, regardless of consumer, and all transaction records available in the database involving the consumer, regardless of maker or card issuer.

Server 200 compiles the transaction data retrieved at 88 and 90 into a request for guarantee at 91 and transmits the compiled data in an auction request to one or more check guarantor entities 94, at 92.

Referring also to FIG. 3C, as indicated at 96, the sequence by which the auction offer can be transmitted/offered to the plurality of check guarantors 94 can vary. In a sequence indicated at 98, for example, the load network transmits the offer sequentially, asking first one, and then a next, guarantor entity 94 until a guarantor accepts the offer. The order in which guarantors are queried may be established in various ways, e.g. by a randomly generated sequence or by a predetermined order in which slots in the order are reserved by the guarantors in the enrollment process with the funds network.

Referring to the detail of procedure 98 at FIG. 3D, server 200 checks a table in database 202 at 85 to determine the first guarantor 94 to which to submit the request for guarantee. Server 200 submits the request electronically over a network connection to the first check cashing guarantor 94 indicated at 85, pursuant to a pre-existing agreement between the guarantor and the funds network enrolling the guarantor with the funds network. If the first vendor identified at 85 accepts the request, and agrees to guarantee the check, at 87, the check guarantee process is concluded at 104. If the first check cashing guarantor 94 does not accept the request, or does not approve the check, at 87, server 200 submits the request to the next check cashing guarantor indicated at 85, at 89, again pursuant to an enrollment contract. If this guarantor accepts the request and agrees to guarantee the check, the check cashing guarantee procedure ends at 104. If not, server 200 submits the request sequentially to the check cashing guarantors in the order identified at step 85, repeating the process until either a check cashing guarantor guarantees the check, thereby advancing the process to step 104, or all check cashing guarantors either refuse the process and/or reject the check at 93. In the latter event, the customer is notified via the check-cashing entity at computers 206 or 208 at 95 that the check has been declined. Server 200 stores a data record reflecting the transaction (e.g. check maker, check type, check amount, and result) in the transaction record table of database 202, and the process terminates.

Returning to FIG. 3C, in a sequence indicated at 100, the funds network simultaneously submits the auction request to all guarantors 94 enrolled with the funds network, selecting the first guarantor 94 to accept the offer. In a sequence indicated at 102, the load network selects a guarantor 94 in an order based upon a predetermined criteria, selecting the first guarantor 94 to accept the offer. The criteria can vary as desired and is not, in and of itself, a part of the present invention. For example, the server may select guarantors based on fees, going first to guarantors with lower fees, and/or transaction-based criteria, such as whether guarantors have preferences for transaction amount ranges or check types.

As should be understood in the check-cashing art, the check guarantor analyzes the check data and the customer data and makes a decision whether to guarantee the check. If, at 104, the selected check guarantor 94 transmits to the load network 38 an approval to cash the check, the funds network deducts the check cashing entity's fee (if any) received from 59 (FIG. 3A) and an interchange fee (described below) from the check proceeds at 106, credits a funds network-owned account by the fee and interchange amounts, and records the fee and interchange amounts in a table at 107. The funds network immediately transmits instructions to the card issuer identified from the card data received from 59 to load the customer's account associated with the card with the remaining check proceeds, at 108. Funds network 38 provides these instructions via an API pursuant to an enrollment agreement between the funds network and the card issuer. In this instruction, the funds network identifies the consumer, the card number, and the load amount. From its local accounts, the card issuer deposits funds equal to the load amount into an account associated with the card number. From the card issuer's perspective, the funds network is liable to the card issuer for the funds, regardless of the underlying check's validity. Typically, although not necessarily, the funds network and the guarantor 94 that guarantees the check have an agreement under which the guarantor assumes the risk of loss if the check is returned. The funds network transmits a receipt to the customer via the check-cashing entity and computer 206 or 208, at 112.

Alternatively, the funds network may transfer funds to the card account manager at step 108, rather than sending instructions. In that event, the funds network would not transfer funds to the card account manager at step 127 (described below), and that step can be replaced by a step of applying check proceeds to a funds network account, if the check clears.

At 110, and also referring to FIG. 3E, the funds network deposits the face amount of the underlying check (i.e. the amount for which the check was made, without reduction for any fees) in a funds network fiduciary account at a clearing bank, and electronically transmits a copy of the image of the check for settlement via the Check 21 protocol to the clearing bank. At 111, the funds network adds a data record to the transaction record table at database 202, recording the consumer identity, maker identity, check number, check type, check amount, check-cashing entity identification, date, interchange and check-cashing entity fees, and the identity of the card issuer receiving load. As should be understood, the Check 21 settlement procedure requires that a check be cleared within a two day period. If the check clears at 113, then at 115, the funds network updates the transaction record for this check in the transaction record table at database 202, and this part of the process ends. The check maker's bank forwards the check face amount to the clearing back noted above. In turn, the clearing bank forwards the check face amount to an account designated by the funds network. The funds network distributes the check proceeds as described in more detail below.

If the check does not clear at 113, the clearing bank receives notice of the returned check at 117. The clearing bank notifies the funds network of the returned check, and the funds network appends the returned check notice to a table in database 202 that holds information relating to returned checks, at 119, and updates the check's transaction record in database 202 to indicate a returned check, at 115. At 121, pursuant to an agreement between the funds network and the check guarantor that guarantees the check, the funds network provides notice to the check guarantor, for example automatically through an API established pursuant to the enrollment agreement, that the check was returned and requesting that the guarantor indemnify the funds network for the check face amount. In response, the check guarantor transfers, for example by electronic funds transfer or automated clearing house transfer, the face amount of the check to an account designated by the funds network.

In another embodiment, the funds network does not present the check transaction to a guarantor selection procedure, but instead accepts the liability within the funds network alone. In that instance, and returning to FIG. 3B, the funds network acquires the information from step 84 and makes its own assessment whether to approve the check. In this instance, the funds network computer system receives confirmation to fund the check from the funds network entity as part of the entity's internal operation. Thus, and referring to FIG. 3C, the funds network's decision is reflected at step 104, and the process proceeds from that point as discussed above, except that in the event the check is returned at step 113 (FIG. 3E), step 121 is omitted, and loss on the check remains with the funds network.

Regardless whether the check clears, and referring to FIG. 3F, after the check is submitted for settlement at steps 110-111, the funds network pauses for a predetermined period of time, for example two business days, to permit the check to clear and funds to be returned from the check, as indicated at 123. After the pause, and again regardless whether the underlying check clears, the funds network allocates the total face amount according to the steps indicated at 125, 127, and 129. At 125, the funds network allocates the interchange fee to the funds network. This is an accounting remittance and does not necessarily involve an actual transfer of funds, although it is possible to move funds between funds network accounts for this purpose.

The interchange is a fee established by agreement between the funds network and the card issuer to which the load amount is sent at 108 (FIG. 3C). The interchange can be established in any manner agreeable between the parties, but in this example is set as a percentage of the check face amount, for example 3%. Thus, at step 127, 3% of the check face value is allocated to the interchange.

At step 129, the initial fee charged by the check-cashing entity and reported to the funds network from 59 (FIG. 3A), if any, is transferred by the funds network, for example by electronic funds transfer or automated clearing house transfer, from a funds network account to the check cashing entity. At 127, the remainder (i.e. the check face value, less the interchange and the check-cashing entity fee) is transferred by the funds network from a funds network account to the card issuer.

At 131, 133 and 135, the funds network allocates a portion of the interchange to costs associated with the transaction. For instance, if the funds network obtains a guarantee of the check from a check guarantor 94, there will generally be a per-transaction fee owed by the funds network to the check guarantor pursuant to an agreement between those parties. The funds network therefore transfers this fee at 131 from a funds network account to the check guarantor. Similarly, the funds network and the check-cashing entity may have an agreement under which the funds network remits to the check-cashing entity a per-transaction fee. This fee is independent of fees that the check-cashing entity may charge the consumer as shown in FIG. 3A. At 133, the funds network transfers this fee amount from a funds network account to the check-cashing entity. Moreover, as should be understood in the art of settlement transactions, there are costs associated with the settlement process, and the funds network may transfer funds from a funds network account at 133 to pay these costs. The difference between the interchange fee and the sum of the fees and costs paid at step 131, 133 and 135 represents the per-transaction net revenue to the funds network.

Referring now to FIG. 3G, if the check load request from step 56 indicates at 58 (FIG. 3B) that the customer has an e-wallet account with the funds network, then steps 62 through 74 in FIG. 3B are unnecessary, and the answer to step 76 is “yes.” Accordingly, server 200 executes steps 78-135 as discussed above with respect to FIGS. 3B-3D, 3E, and 3F, except that step 108 changes to transfer of funds to the funds network's e-wallet associated account and an update of the consumer's record in the funds network database to reflect the increased e-wallet balance, and that settlement at step 127 is to the funds network e-wallet account. If a check-cashing guarantee is not obtained at 104, the transactions ends, and the data store is updated, at 95, as discussed above. If, however, a check guarantee is obtained at 104, the load network submits the check for processing and settlement at 110 (FIG. 3C). At step 127 (FIG. 3F), server 200 (FIG. 4) allocates to the customer's e-wallet account identified at 58 the check proceeds, less the interchange and check-cashing entity independent fee.

If the consumer wishes, at this or a later time, to withdraw funds in the e-wallet account (whether maintained by the funds network or a third party), the consumer may access the account through the funds network or third party independently of the load and allocation functions discussed herein. If, however, the consumer wishes to allocate funds from the e-wallet to a monetary repository maintained by a manager enrolled with funds network to receive good funds, the consumer may access funds network server 200 directly via a funds-network owned kiosk 208 or a consumer-controlled computer 206 (FIG. 4), such a mobile telephone with a suitable application, at 114. Alternatively, if the consumer executed a load transaction discussed above via a direct connection with the load network over such a device, the consumer may execute an option through the funds network user interface to move from loading mode to allocation mode, as indicated by the line between 110 and 111 in FIG. 3G. Upon accessing the funds network through such a connection and indicating a desire to disburse funds from the e-wallet at 114, server 200 presents to the consumer (via a user interface presented at the consumer's computing device) a query whether the consumer wishes to disburse funds from its e-wallet account to an existing monetary repository associated in a table of database 202 with that e-wallet account, at 116. If the consumer indicates at 116 that the consumer does not wish to load e-wallet funds to an existing repository, server 200 prompts the consumer or operator to enter information identifying the new repository. In response to the prompt, for example, the consumer or operator swipes or otherwise identifies or images a new card at the computer 206 or 208, or other computing device, at 120. If the BIN portion of the new card number does not match an enrolled card issuer, the transaction ends, as at 95. If the BIN does match a card issuer, then at 120 server 200 queries the card issuer via the API associated with that issuer, obtains card data, and creates a record in the database table, associating the new card with the e-wallet account, at 122.

If the customer indicates that it wishes to disburse funds from the e-wallet account to an existing repository at 116, server 200 queries database 202 to identify from the database table those customer-associated repositories that are available to this particular customer. For example, the particular consumer may have set up an account to enable the consumer to pay utility or other personal bills, and/or an account by which the consumer may make money transfers 22, and/or two reloadable debit cards 20. If the consumer has a direct deposit bank account, the customer may also disburse funds from its e-wallet account to the direct deposit bank account, as indicated at 126.

Having identified the available consumer-associated accounts at 124, server 200 presents via the user interface a selection window through which the customer selects the desired customer-associated account or other repository, at 128. Server 200 then queries the consumer via the user interface to enter the amount of the desired disbursement. The consumer enters this information to server 200 via computer 206 or 208 or other computing device at 132. If the requested load amount is within the amount present in the e-wallet account, the requested load amount is accepted, and a fee charged by the funds network pursuant to the e-wallet or, alternatively, is allocated in addition to the load amount agreement between the funds network and the consumer is deducted from the requested load amount. At 134, the funds network debits its (or requests a debit of the third party) e-wallet account by the load amount and the fee, and the funds network sends a load request to the requested customer-associated account or repository, as at step 108 (FIG. 8C). Pursuant to the contract between the load network and the repository manager, the load amount is settled between an account owned by the load network and an account owned by the account manager in due course. The fee is settled from the e-wallet account to a funds network account. At 136, server 200 notifies the customer via the user interface of the remaining balance in the e-wallet account.

At 138, server 200 queries the customer via the user interface whether an additional load is desired. If the customer responds in the negative, server 200 transmits to the customer via the user interface a receipt for the transaction, at 112. If the customer desires another load transaction at 138, the procedure returns to step 118.

While the above description is set forth with respect to one or more embodiments, it should be appreciated the principles of the present invention are equally applicable to other embodiments within the scope of the present disclosure and claims. Such other modifications and variations to the present invention may be practiced by those of ordinary skill in the art, without departing from the spirit and scope of the present invention, one or more embodiments of which are more particularly set forth in the appended claims. In addition, it should be understood that aspects of the various embodiments described herein and otherwise may be interchanged both in whole or in part. Furthermore, those of ordinary skill in the art will appreciate that the foregoing description is by way of example only and is not intended to be limitative of the invention so further described in such appended claims.

What is claimed is:

1. A method of providing funds to a monetary repository, where the funds originate from a negotiable instrument made to a payee, the method comprising the steps of:
providing a computerized system that is accessible to remote parties through a computer network and that is controlled by an entity;
receiving, at the computerized system through the computer network, information identifying a payee and indicating a request from the payee to convert a negotiable instrument made to the payee to funds;
receiving, through the computer network, an image of the negotiable instrument endorsed to the entity;
receiving, at the computerized system and in response to the information, confirmation to convert the negotiable instrument to funds;
directing, through the computer network, payment of an amount of funds corresponding to a value of the negotiable instrument to a monetary repository designated by or associated with the payee; and
directing, through the computer network, settlement of the negotiable instrument with recourse to the entity.

2. The method as in claim 1, wherein the repository is controlled by a manager, and the entity is the manager.

3. The method as in claim 1, wherein the repository is controlled by a manager, and the entity and the manager are independent of each other.

4. The method as in claim 1, wherein the repository is controlled by a manager, and comprising establishing an agreement between the entity and the manager pursuant to which the entity may provide funds to the manager without recourse to the manager and the entity charges fees based on transfer of funds to the repository.

5. The method as in claim 4, wherein the transfer is effected through automated clearinghouse settlement.

6. The method as in claim 1, wherein the confirmation is received by a negotiable instrument guarantor that is independent of the entity.

7. The method as in claim 6, comprising establishing an agreement between the entity and the independent negotiable instrument guarantor that allocates risk of rejection of payment of a negotiable instrument for which a determination is made to convert to funds.

8. The method as in claim 6, wherein the repository is controlled by a manager, and the entity and the manager are independent of each other.

9. The method as in claim 6, wherein the entity selects a respective said independent negotiable instrument guarantor with which to confirm whether to convert respective said negotiable instruments to funds, from among a plurality of negotiable instrument guarantors.

10. The method as in claim 9, wherein the entity extends offers sequentially to the guarantors in the plurality of negotiable instrument guarantors and selects as the respective independent negotiable instrument guarantor a first said guarantor in the plurality of negotiable instrument guarantors to accept an offer extended by the entity.

11. The method as in claim 9, wherein the entity extends offers simultaneously to the guarantors in the plurality of negotiable instrument guarantors and selects as the respective independent negotiable instrument guarantor a first said guarantor in the plurality of negotiable instrument guarantors to accept an offer extended by the entity.

12. The method as in claim 9, wherein the entity selects as the respective independent negotiable instrument guarantor a guarantor in the plurality of negotiable instrument guarantors based on application of predetermined criteria to characteristics of at least one of:
one or more of the guarantors in the plurality of negotiable instrument guarantors,
the negotiable instrument, and
the payee.

13. The method as in claim 1, wherein the repository is a deposit bank account owned by the entity.

14. The method as in claim 13, wherein the entity allocates portions of funds deposited in the deposit bank account to individual said payees for whom the entity deposits funds into the deposit bank account.

15. The method as in claim 1, comprising establishing respective agreements between the entity and a plurality of banks, each bank controlling at least one said repository, pursuant to which the entity may provide funds to the respective bank without recourse to the respective bank and the entity charges fees based on transfer of funds to the repository controlled by the respective bank.

16. The method as in claim 1, comprising
storing records of transactions requested through the computerized system in which a payee requests conversion of a negotiable instrument to funds,
wherein the confirmation is received from a negotiable instrument guarantor,
retrieving information from the records having a predetermined relationship to a transaction requested at the first receiving step, and
providing the retrieved information to the negotiable instrument guarantor with a request to the negotiable instrument guarantor for a confirmation whether to convert the negotiable instrument to funds.

17. The method as in claim 16, wherein the retrieved information is selected based on said records of transactions having a common payee with the transaction requested at the first receiving step.

18. The method as in claim 16, wherein the retrieved information is selected based on said records of transactions having a common maker with the transaction requested at the first receiving step.

19. The method as in claim 16, wherein the retrieved information is selected based on said records of transaction having a common payee or maker with the transaction requested at the first receiving step.

20. A method of providing funds to a monetary repository, where the funds originate from a negotiable instrument made to a payee, the method comprising the steps of:
providing a computerized system that is accessible to remote parties through a computer network and that is controlled by an entity;
receiving, at the computerized system through the computer network, a request to convert a negotiable instrument made to the payee to funds;
receiving, at the computerized system through the computer network, an image of the negotiable instrument endorsed to the entity;
receiving, at the computerized system, confirmation to convert the negotiable instrument to funds;
directing, from the computerized system through the computer network, payment of an amount of funds corresponding to a value of the negotiable instrument to a monetary repository designated by or associated with the payee; and
directing, from the computerized system through the computer network, settlement of the negotiable instrument with recourse to the entity.

21. The method as in claim 20, wherein the confirmation is received by a negotiable instrument guarantor that is independent of the entity.

22. The method as in claim 21, wherein the entity selects a respective said independent negotiable instrument guarantor with which to confirm whether to convert respective said negotiable instruments to funds, from among a plurality of negotiable instrument guarantors.

23. The method as in claim 22, wherein the entity extends offers sequentially to the guarantors in the plurality of negotiable instrument guarantors and selects as the respective independent negotiable instrument guarantor a first said guarantor in the plurality of negotiable instrument guarantors to accept an offer extended by the entity.

24. The method as in claim 22, wherein the entity extends offers simultaneously to the guarantors in the plurality of negotiable instrument guarantors and selects as the respective independent negotiable instrument guarantor a first said guarantor in the plurality of negotiable instrument guarantors to accept an offer extended by the entity.

25. The method as in claim 22, wherein the entity selects as the respective independent negotiable instrument guarantor a guarantor in the plurality of negotiable instrument guarantors based on application of predetermined criteria to characteristics of at least one of:
one or more of the guarantors in the plurality of negotiable instrument guarantors,
the negotiable instrument, and
the payee.

26. The method as in claim 20, comprising
storing records of transactions requested through the computerized system in which a payee requests conversion of a negotiable instrument to funds,
wherein the confirmation is received from a negotiable instrument guarantor,
retrieving information from the records having a predetermined relationship to a transaction requested at the first receiving step, and
providing the retrieved information to the negotiable instrument guarantor with a request to the negotiable instrument guarantor for a confirmation whether to convert the negotiable instrument to funds

27. The method as in claim 26, wherein the retrieved information is selected based on said records of transactions having a common payee with the transaction requested at the first receiving step.

28. The method as in claim 26, wherein the retrieved information is selected based on said records of transactions having a common maker with the transaction requested at the first receiving step.

29. The method as in claim 26, wherein the retrieved information is selected based on said records of transaction having a common payee or makes with the transaction requested at the first receiving step.

30. A method of providing funds to a monetary repository, where the funds originate from a negotiable instrument made to a payee, the method comprising the steps of:
providing a computerized system that is accessible to remote parties through a computer network and that is controlled by an entity;
receiving, at the computerized system through the computer network and from an acquirer of a negotiable instrument made to a payee, information identifying the payee and indicating a request to convert the negotiable instrument to funds, wherein the acquirer is remote from the computerized system;
receiving from the acquirer, at the computerized system through the computer network, an image of the negotiable instrument endorsed to the entity;
receiving, at the computerized system, confirmation to convert the negotiable instrument to funds;
directing, from the computerized system through the computer network, payment of an amount of funds corresponding to a value of the negotiable instrument to a monetary repository designated by or associated with the payee; and
directing, from the computerized system through the computer network, settlement of the negotiable instrument with recourse to the entity.

31. The method as in claim 30, wherein the confirmation is received by a negotiable instrument guarantor that is independent of the entity.

32. The method as in claim 31, wherein the entity selects a respective said independent negotiable instrument guarantor with which to confirm whether to convert respective said negotiable instruments to funds, from among a plurality of negotiable instrument guarantors.

33. The method as in claim 32, wherein the entity extends offers sequentially to the guarantors in the plurality of negotiable instrument guarantors and selects as the respective independent negotiable instrument guarantor a first said guarantor in the plurality of negotiable instrument guarantors to accept an offer extended by the entity.

34. The method as in claim 32, wherein the entity extends offers simultaneously to the guarantors in the plurality of negotiable instrument guarantors and selects as the respective independent negotiable instrument guarantor a first said guarantor in the plurality of negotiable instrument guarantors to accept an offer extended by the entity.

35. The method as in claim 32, wherein the entity selects as the respective independent negotiable instrument guarantor a guarantor in the plurality of negotiable instrument guarantors based on application of predetermined criteria to characteristics of at least one of:
one or more of the guarantors in the plurality of negotiable instrument guarantors,
the negotiable instrument, and
the payee.

36. The method as in claim 30, comprising
storing records of transactions requested through the computerized system in which a payee requests conversion of a negotiable instrument to funds,
wherein the confirmation is received from a negotiable instrument guarantor,
retrieving information from the records having a predetermined relationship to a transaction requested at the first receiving step, and
providing the retrieved information to the negotiable instrument guarantor with a request to the negotiable instrument guarantor for a confirmation whether to convert the negotiable instrument to funds

37. The method as in claim 36, wherein the retrieved information is selected based on said records of transactions having a common payee with the transaction requested at the first receiving step.

38. The method as in claim 36, wherein the retrieved information is selected based on said records of transactions having a common maker with the transaction requested at the first receiving step.

39. The method as in claim 36, wherein the retrieved information is selected based on said records of transaction having a common payee or makes with the transaction requested at the first receiving step.

40. A system for providing funds to a monetary repository, where the funds originate from a negotiable instrument made to a payee, comprising:
a computer-readable medium containing program instructions, and
a processor that is accessible to remote parties through a computer network and that is controlled by an entity, the processor being in operative communication with the computer-readable medium and adapted to execute the program instructions to implement a method comprising the steps of
receiving, from the computer network, a request to convert a negotiable instrument made to the payee to funds,
receiving, from the computer network, an image of the negotiable instrument endorsed to the entity,
receiving confirmation to convert the negotiable instrument to funds,
directing, through the computer network, payment of an amount of funds corresponding to a value of the negotiable instrument to a monetary repository designated by or associated with the payee, and
directing, through the computer network, settlement of the negotiable instrument with recourse to the entity.
